(19) United States
(12) Patent Application Publication
(10) Pub. No.: US 2012/0027092 A1
(43) Pub. Date: Feb. 2, 2012

(54) IMAGE PROCESSING DEVICE, SYSTEM AND METHOD

(75) Inventor: Hajime Matsui, Kawasaki-shi (JP)

(73) Assignee: KABUSHIKI KAISHA TOSHIBA, Tokyo (JP)

(21) Appl. No.: 12/886,707

(22) Filed: Sep. 21, 2010

(30) Foreign Application Priority Data
Jul. 30, 2010 (JP) 2010-172465

(51) Int. Cl. H04N 7/26

(52) U.S. Cl. 375/240.16; 375/E07.125

(57) ABSTRACT

According to one embodiment, an image processing device includes a motion detector, a weight predictor, a reference frame selector, an inter-frame predictor, a subtractor, an orthogonal-transferring-quantization module, and an encoder. The motion detector is configured to generate a motion vector using a luminance component of a first reference frame and a luminance component of an encoding target macro block in an input video signal. The weight predictor is configured to generate a second reference frame. The reference frame selector is configured to select one of the first reference frame and the second reference frame as an optimum reference frame. The inter-frame predictor is configured to generate an inter-frame prediction image based on the motion vector and the selected optimum reference image. The subtractor is configured to calculate a prediction residual image between the encoding target macro block and the inter-frame prediction image.

### CROSS REFERENCE TO RELATED APPLICATIONS

This application is based upon and claims the benefit of priority from the prior Japanese Patent Application No. 2010-172465, filed on Jul. 30, 2010, the entire contents of which are incorporated herein by reference.

### FIELD

Embodiments described herein relate generally to image processing device, system and method.

### BACKGROUND

In order to store a high quality moving image in a hard disk and so on whose storage capacity is limited, a technique for compression-coding the moving image efficiently has become important. Therefore, in some moving image compression-coding scheme such as an H.264, an inter-frame motion prediction coding is performed. The inter-frame motion prediction coding is a technique where an inter-frame prediction image is generated by way of motion detection and a difference between the inter-frame prediction image and an actual image is compression-coded. Because there is a high degree of correlation between frames in the moving image, if a precise inter-frame prediction image can be generated, the moving image can be compressed with a high compression ratio while not degrading the image quality.

In order to generate the precise inter-frame prediction image, it is necessary to search a part having the high degree of correlation between the frames by performing a number of times of block matching in the motion detection. Therefore, the motion detection needs a large number of operations and memory accesses. Accordingly, even when the moving image is composed of a luminance component and color difference components, the motion detection is mostly performed using only the luminance component.

However, if the motion prediction is performed using only the luminance component, the accuracy of the motion prediction can be lowered with respect to an image whose luminance component is even and color difference component is uneven. As a result, there is a likelihood that the image quality of the compression-coded moving image can be degraded.

### BRIEF DESCRIPTION OF THE DRAWINGS

FIG. 1 is a block diagram showing a schematic configuration of an image processing system according to a first embodiment.

FIG. 2 is a flowchart showing an example of processing operations of the image processor 100.

FIG. 3A shows the encoding target MB.

FIG. 3B shows the first inter-frame prediction image.

FIG. 3C shows the second inter-frame prediction image.

FIGS. 4A and 4B are examples of the prediction residual image.

FIG. 5 is a block diagram showing a schematic structure of the image processing system according to the second embodiment.

FIG. 6 is a flowchart showing an example of the image processing device 100 of FIG. 5.

FIG. 7 is an example of the intra-frame prediction image.

FIG. 8 is an example of the third prediction residual image.

### DETAILED DESCRIPTION

In general, according to one embodiment, an image processing device includes a motion detector, a weight predictor, a reference frame selector, an inter-frame predictor, a subtractor, an orthogonal-transferring-quantization module, and an encoder. The motion detector is configured to generate a motion vector using a luminance component of a first reference frame and a luminance component of an encoding target macro block in an input video signal, the first reference frame being obtained by decoding an encoded frame. The weight predictor is configured to generate a second reference frame having a luminance component identical to the luminance component of the first reference frame and color difference components different from the color difference components of the first reference frame. The reference frame selector is configured to select one of the first reference frame and the second reference frame as an optimum reference frame, the optimum reference frame being selected to enhance an encoding efficiency. The inter-frame predictor is configured to generate an inter-frame prediction image based on the motion vector and the selected optimum reference image. The subtractor is configured to calculate a prediction residual image between the encoding target macro block and the inter-frame prediction image. The orthogonal-transferring-quantization module is configured to generate quantized data by orthogonal-transferring and quantizing the prediction residual image. The encoder is configured to generate the output video signal by encoding the quantized data.

Embodiments will now be explained with reference to the accompanying drawings.

### First Embodiment

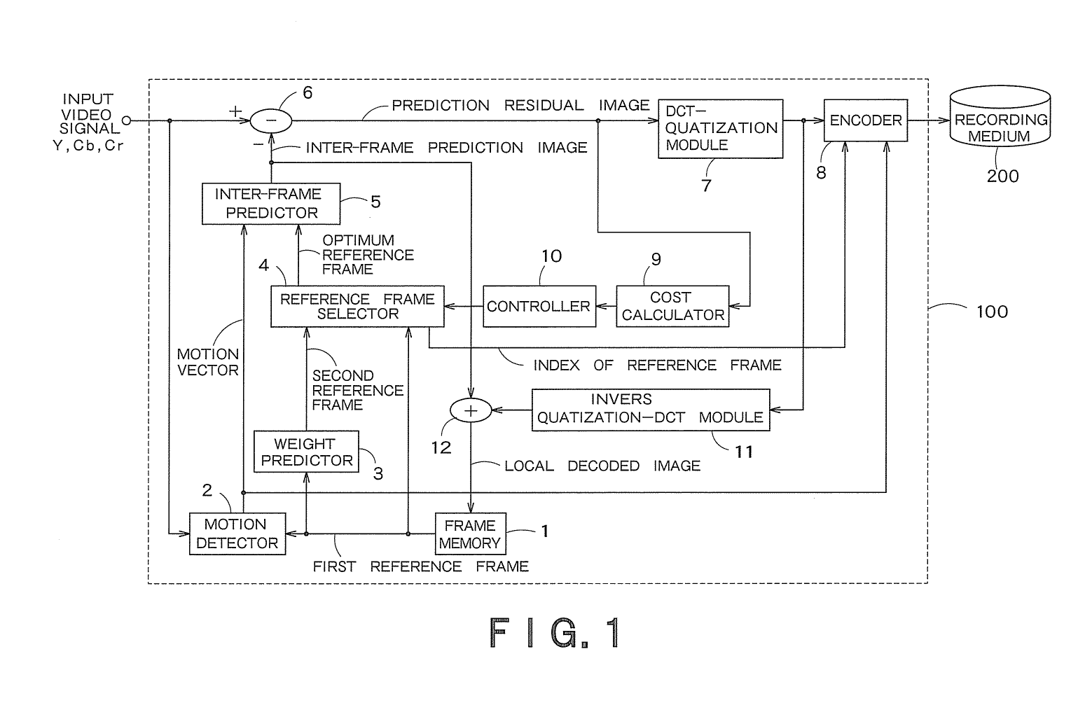

FIG. 1 is a block diagram showing a schematic configuration of an image processing system according to a first embodiment. The image processing system of FIG. 1 has an image processing device 100 and a recording medium 200.

The image processor 100 of the present embodiment compression-codes an input video signal expressed by a luminance component Y and color difference components Cb, Cr by performing an inter-frame motion prediction in an H.264 scheme. Furthermore, the recording medium 200 is a hard disk or a flash memory, for example, and stores a compression-coded video signal.

The image processing system of the present embodiment can be integrated in a digital video camera, and a photographed image is compression-coded by the image processor 100 to be stored in the recording medium 200, for example. The image processing system can also be integrated in a DVD recorder, and a broadcast wave is compression-coded by the image processor 100 to be stored in the recording medium 200.

The image processor 100 has a frame memory 1, a motion detector 2, a weight predictor 3, a reference frame selector 4, an inter-frame predictor 5, a subtractor 6, a DCT-quantization module (orthogonal transforming-quantization module) 7, an encoder 8, a cost calculator 9, a controller 10, an inversion quantization-DCT module 11, and an adder 12.

The frame memory 1 stores a local decoded image obtained by decoding an encoded frame. The motion detector 2 generates a motion vector by using the local decoded image stored in the frame memory 1 as a first reference frame and performing block matching between the luminance component Y of the first reference frame and that of the input video signal.

The weight predictor 3 generates a second reference frame by performing a weighting operation on the color difference components Cb, Cr of the first reference frame. Here, the luminance component Y of the first reference frame and that of the second reference frame are the same, while the color difference components Cb, Cr of the first reference frame and those of the second reference frame are not the same. The reference frame selector 4 selects one of the first reference frame and the second reference frame as an optimum reference frame according to the control of the controller 10. The inter-frame predictor 5 generates an inter-frame prediction image based on the motion vector and the optimum reference frame.

The subtractor 6 generates a prediction residual image by calculating difference data between the input video signal and the inter-frame prediction image. The DCT-quantization module 7 generates quantized data by performing DCT (Discrete-Cosine-Transforming) and quantization of the prediction residual image. The encoder 8 generates an output video signal by variable-length-coding the quantized data, the motion vector and an index of the optimum reference frame.

The cost calculator 9 calculates a first cost and a second cost. The first cost indicates an encoding efficiency in the case where the input video signal is compression-coded by using the first reference frame. The second cost indicates an encoding efficiency in the case where the input video signal is compression-coded by using the second reference frame. The controller 10 compares the first cost with the second cost and controls the reference frame selector 4 to select one of the reference frames so that the encoding efficiency becomes higher. Here, the encoding efficiency means a balance between a quality of the image corresponding to the output video signal and a compression ratio.

The inverse quantization-DCT module 11 generates a prediction residual decoded image by performing an inverse quantization and an inverse discrete-cosine-transform on the quantized data. The adder 12 generates the local decoded image by adding the inter-frame prediction image to the prediction residual decoded image.

It is one of the characteristic features of this embodiment to estimate, in advance, the encoding efficiency in the case where the input video signal is compression-coded using the first and the second reference frames whose luminance components Y are the same and color difference components Cb, Cr are different from each other, in order to compression-code the input video signal by selecting the reference frame capable of being compression-encoded more efficiently and generating the inter-frame prediction image using the selected reference frame. Hereinafter, this feature will be mainly explained.

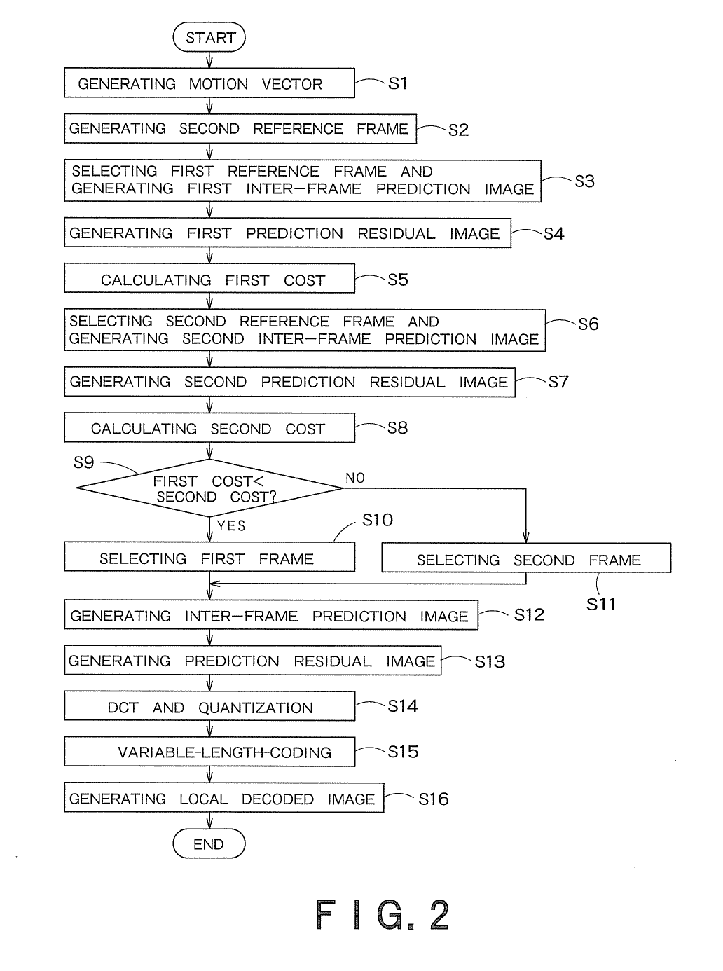

FIG. 2 is a flowchart showing an example of processing operations of the image processor 100. The processing operations of FIG. 2 are performed in units of a macro block (hereinafter, MB), which has a plurality of pixels in the encoding target frame in the input video signal. The MB has “256” pixels, namely, “16” pixels in the horizontal direction and “16” pixels in the vertical direction (16*16 pixels), for example.

Firstly, the motion detector 2 performs the block matching between motion compensation blocks in the first reference frame stored in the frame memory 1 and those in the encoding target MB. Then, the motion detector 2 detects the motion compensation block in the first reference frame which is the most similar to that in the encoding target MB. By such a manner, the motion detector 2 generates the motion vector indicating which direction and how much the motion compensation block moves (S1).

The motion compensation block means a unit for generating the motion vector. The size of the motion compensation block can be the same as that of the MB or can be smaller than that of the MB. For example, when the size of the MB is 16*16 pixels, the size of the motion compensation block can be 16*16 or smaller size, namely, 16*8, 8*16 or 8*8 pixels. When the size of the motion compensation block is smaller than that of the MB, a plurality of motion vectors are generated in the MB.

Here, although the input video signal is composed of the luminance component Y and the color difference components Cb, Cr, the motion detector 2 performs the block matching using only luminance component Y of the first reference component and that of the input video signal to generate the moving vector. The motion detector 2 does not perform the block matching using the color difference components Cb, Cr, thereby decreasing the number of accesses to the frame memory 1 and the amount of the operation for the block matching.

Secondly, the weight predictor 3 performs the weighting operation on the first reference frame to generate the second reference frame, whose luminance component Y is the same as that of the first reference frame and the color difference components Cb, Cr are not the same as those of the first reference frame (S2). In the present embodiment, the color difference components Cb, Cr are dealt with as fixed values. Each parameter defined in the H.264 scheme is set as shown in the following equations (1) to (4), respectively, for example, and the weight predictor 3 performs the weighting operation based on the set parameters.

luma_weight_lx_flag=0 (1)

chroma_weight_lx_flag=1 (2)

chroma_weight_lx[0]=chroma_weight_lx[1]=0 (3)

chroma_offset_lx[0]=chroma_offset_lx[1]=128 (4)

The parameter luma_weight_lx_flag in the above equation (1) is a parameter indicative of whether or not to perform the weighting operation on the luminance component Y. When the parameter is set to be “0”, the weighting operation is not performed. Accordingly, the luminance component Y of the second reference frame can be set to be that of the first reference frame.

The parameter chroma_weight_lx_flag in the above equation (2) is a parameter indicative of whether or not to perform the weighting operation on the color difference components Cb, Cr. When the parameter is set to be “1”, the weighting operation is performed. Accordingly, the second reference frame can be generated whose color difference components Cb, Cr are not the same as those of the first reference frame.

The parameters chroma_weight_lx[0] and chroma_weight_lx[1] in the above equation (3) are constants (first constant) multiplied by the color difference components Cb, Cr, respectively. Furthermore, the parameters chroma_offset_lx[0] and chroma_offset_lx[1] in the above equation (4) are constants (second constant) added to the color difference components Cb, Cr, respectively.

That is, the weighting operation on the color difference component Cb is to multiply the parameter chroma_weight_lx[0] by the color difference component Cb, and then add the parameter chroma_offset_lx[0] to the multiplied value, to generate the color difference component Cb of the second reference frame. The weighting operation on the color difference component Cr is similar to the above.

In the present embodiment, the parameters chroma_weight_lx[i] (i=0, 1) are set to be “0”. Because of this, the color difference components Cb, Cr become fixed values in the MB. Furthermore, the parameters chroma_offset_lx[i] are set to be “128”. This is an example where the color difference components Cb, Cr are expressed by digital signals of “8” bits. More generally, the parameters chroma_offset_lx[i] are set to be a rounded value of half of the maximum value of the color difference components Cb, Cr. Such color difference components Cb, Cr are a so-called achromatic color.

By setting above, the parameters chroma_offset_lx[i] can be simply set. However, in this case, because the second reference frame is the achromatic color, the prediction accuracy may be worsened when the color of the MB is extremely deep and so on.

On the other hand, averages of the color difference components Cb, Cr of the encoding target frame are calculated in advance, and the parameters chroma_offset_lx[i] can be set to the averages. Although the processing operation for calculating the averages is required, the color difference components of the second reference frame can be set near the MB, thereby improving the prediction accuracy.

After the second reference frame is generated, one of the first reference frame and the second reference frame is selected as the optimum reference frame by the following S3 to S11.

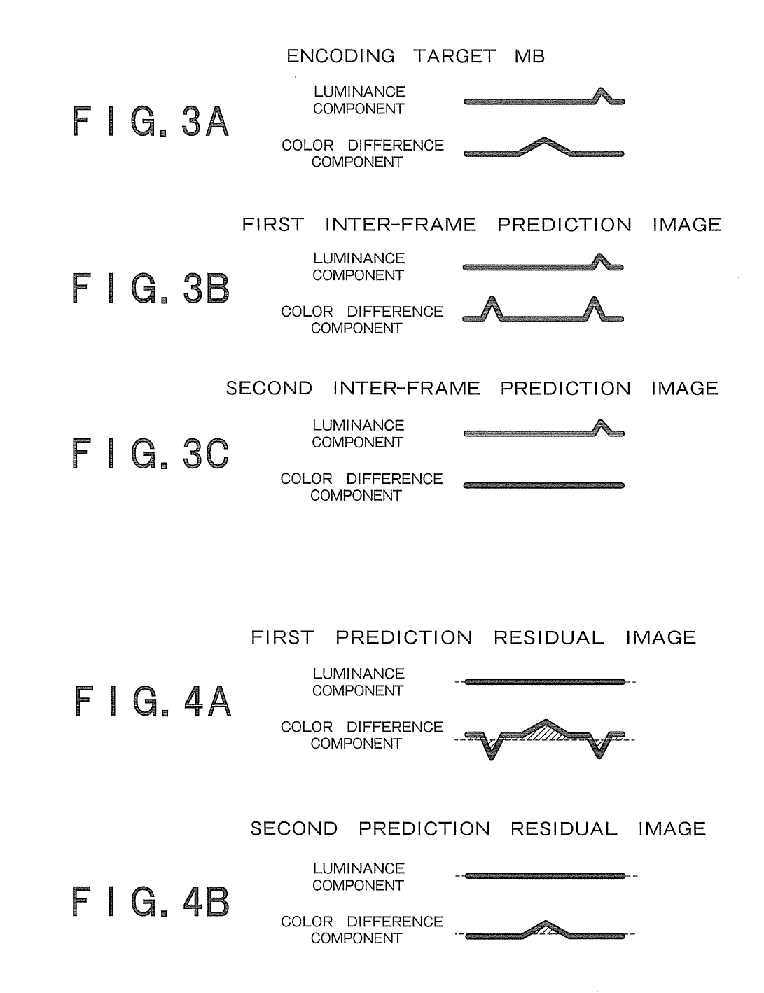

Firstly, the first reference frame is selected by the reference frame selector 4, and the inter-frame predictor 5 generates a first inter-frame prediction image based on the first reference frame and the motion vector (S3). FIGS. 3A to 3C are examples of the luminance component Y and the color difference component Cb, Cr of the encoding target MB and the inter-frame prediction image. For simplification, the luminance component Y and one of the color difference components Cb, Cr in the encoding target MB is shown in one dimension. FIG. 3A shows the encoding target MB, and FIG. 3B shows the first inter-frame prediction image.

As described above, the motion vector is generated by using only the luminance component Y. Therefore, with regard to the luminance component Y of the first inter-frame prediction image, the prediction accuracy is high, and the luminance component Y of the encoding target MB is substantially the same as that of the first inter-frame prediction image. On the other hand, because the motion vector is generated without using the color difference components Cb, Cr, the prediction accuracy of the color difference components Cb, Cr is not necessarily high. Therefore, as shown in FIGS. 3A and 3B, the color difference components Cb, Cr of the encoding target MB may not coincide with those of the first inter-frame prediction image.

Then, the subtractor 6 generates a first prediction residual image by calculating the difference between the encoding target MB and the first inter-frame prediction image by each pixel (S4). FIGS. 4A and 4B are examples of the prediction residual images. The first prediction residual image of FIG. 4A is a difference between the encoding target MB of FIG. 3A and the first inter-frame prediction image of FIG. 3B.

The cost calculator 9 calculates a cost (first cost) in a case of performing the compression-coding by using the first inter-frame prediction image (S5). The cost calculator 9 sets the sum of the absolute values of the prediction residual image, namely, the sum of the absolute differences (SAD) between the encoding target MB and the first inter-frame prediction image by each pixel, as the cost, for example. In this case, the cost corresponds to an area where diagonal lines are drawn in FIG. 4A. As shown in FIG. 4A, the cost of the luminance component Y is substantially “0”. This is because the prediction accuracy of the luminance component Y is high. However, the cost of the color difference components Cb, Cr may be higher than that of the luminance component Y. This is because the prediction accuracy of the color difference component Cb, Cr is not necessarily high.

The cost corresponds to the encoding efficiency and indicates a balance between the quality of the image corresponding to the compression-coded output video signal and the amount of the data of the output video signal. When the cost is large, the prediction residual image has a large value. In the inter-frame motion prediction, the prediction residual image is compression-coded. If the input video signal is compression-coded with a constant compression ratio when the cost is large, the amount of the data of the output video signal may be large. However, the storage capacity of the recording medium 200 is limited. Therefore, in order to perform the compression-coding so that the amount of the data falls within the predetermined amount, the compression ratio has to be larger as the cost is larger. As a result, when the cost is large, the quality of the compression-coded image may be degraded. On the other hand, when the cost is small, because it is unnecessary to enlarge the compression rate, the input video signal can be compression-coded with high quality.

By defining the SAD as the cost, it is possible to simply estimate the encoding efficiency. The controller 10 holds the sum of the cost of the luminance component Y and the cost of the color difference components Cb, Cr as the first cost.

Next, the second reference frame is selected by the reference frame selector 4, and the inter-frame predictor 5 generates a second inter-frame prediction image based on the second reference frame and the motion vector (S6). FIG. 3C shows the second inter-frame prediction image. Because the luminance component Y of the first reference frame is the same as that of the second reference frame, the luminance component Y of the second inter-frame prediction image is the same as that of the first inter-frame prediction image. Contrarily, because the color difference components Cb, Cr of the second reference frame are not the same as those of the first reference frame, the color difference components Cb, Cr of the second inter-frame prediction image are not the same as those of the first inter-frame prediction image.

Then, the subtractor 6 generates a second prediction residual image by calculating the difference between the encoding target MB and the second inter-frame prediction image by each pixel (S7). The second prediction residual image of FIG. 4B is a difference between the encoding target MB of FIG. 3A and the second inter-frame prediction image of FIG. 3C.

The cost calculator 9 calculates a cost (second cost) in a case of performing the compression-coding by using the second inter-frame prediction image (S8). Similar to a case where the first reference frame is selected as shown in FIG. 4A, the cost of the luminance component Y is substantially “0”. However, the cost of the color difference components Cb, Cr is higher than that of the luminance component Y as well. The controller 10 holds the sum of the cost of the luminance component Y and the cost of the color difference components Cb, Cr as the second cost.

Next, the controller 10 compares the first cost with the second cost (S9) and selects one of the first and the second reference frames which has the smallest cost, namely, the highest encoding efficiency. When the first cost is smaller (S9—YES), the controller 10 controls the reference frame selector 4 to select the first reference frame as the optimum reference frame (S10). On the other hand, when the second cost is smaller (S9—NO), the controller 10 controls the reference frame selector 4 to select the second reference frame as the optimum reference frame (S11).

In the example of the encoding target MB shown in FIG. 3A, because the second cost shown in FIG. 4B is smaller than the first cost shown in FIG. 4A (Step S9—NO), the reference frame selector 4 selects the second reference frame (Step S11). For normal images, the first cost, which is obtained by generating the inter-frame prediction image using only the luminance component Y, is smaller than the second cost, while for images whose luminance component Y is even and color difference components Cb, Cr are uneven and so on, the second cost can be smaller than the first cost

Because the reference frame selector 4 selects one of the first and the second reference frames which has the smaller cost, the input video signal can be compression-coded with high quality without lowering the compression ratio.

Then, by using the selected optimum frame, the inter-frame motion prediction coding is performed by the following processings of S12 to S15.

The inter-frame predictor 5 generates the inter-frame prediction image based on the selected optimum frame (the second reference frame for the example of FIG. 3 and FIG. 4) and the motion vector (S12). Furthermore, the subtractor 6 generates the prediction residual image by calculating the difference between the encoding target MB and the inter-frame prediction image (S13). Then, the DCT-quantization module 7 firstly generates DCT data by discrete-cosine transforming (orthogonal transforming) the prediction residual image. By such a manner, redundant components in the encoding target MB can be removed. The DCT-quantization module 7 secondly generates quantized data of an integer by rounding a result obtained by dividing the DCT data by a predetermined quantizing step (S14). The compression ratio depends on the quantizing step and is determined in consideration of the storage capacity of the recording medium 200.

The encoder 8 generates the compression-coded output video signal by variable-length-coding the quantized data added by the motion vector and the index of the selected reference frame (S15). The index of the reference frame means information indicating which of the “first” or the “second” reference frame is selected as the optimum reference frame. Furthermore, the variable-length-coding is a coding scheme where a code with shorter bits is assigned as occurrence frequency is higher, thereby decreasing the amount of the data of the generated output video signal.

In such a manner, the compression-coding of the encoding target MB is completed. The generated output video signal is stored in the recording medium 200.

Note that, information indicating which frame is the first reference frame used when the frame is compression-coded and information indicative of above equations (1) to (4) are added to a header of each frame outputted by the encoder 8. By using the information, a decoder for decoding the compression-coded output video signal (not shown) can generate the second reference frame by performing the weighting operation shown in the above equations (1) to (4) with respect to the first reference frame. Furthermore, because the index of the reference frame for each MB is added, the decoder can generate the inter-frame prediction image based on the first or the second reference frame and the motion vector. Additionally, the decoder can decode the compression-coded output video signal based on the quantized data indicative of the difference between the inter-frame prediction image and the actual image and the inter-frame prediction image.

On the other hand, the inverse quantization-DCT module generates the prediction residual decoded image by performing the inverse quantization and the inverse discrete-cosine-transform of the quantized data generated by the DCT-quantization module 7. Furthermore, the adder 12 generates the local decoded image by adding the prediction residual decoded image by the inter-frame prediction image (Step S16). The frame memory 1 stores the local decoded image. The local decoded image is used for compression-coding the subsequent input video signal. A de-blocking filter can be provided forward of the frame memory 1 to store the decoded image in the frame memory 1 after removing the block noise.

As described above, the first embodiment estimates, in advance, the encoding efficiency in a case of compression-coding the input video signal using the first and the second reference frames whose luminance components Y are the same and color difference components Cb, Cr are different from each other. Furthermore, the inter-frame prediction image is generated by using one of the reference frames capable of being encoded more efficiently. Therefore, the accuracy of the inter-frame prediction improves, thereby compression-coding the moving image with high quality without lowering the compression ratio. Additionally, the amount of the operation can be decreased because the block matching are performed using only the luminance component Y.

Note that, the cost calculator 9 can define the cost C based on the following equation (5) where the SAD is added by a predetermined value λ.

C=SAD+λ*k (5)

The parameter k is a constant, for example. If the reference frame selector 4 selects the first and the second reference frames at the same frequency, the appearance frequencies of the both indexes of the reference frames becomes equal. In this case, the amount of the data generated by variable-length-coding the index of the reference frame becomes large. Therefore, the parameter k is set to be “0” with respect to the first cost in the above equation (5), and the parameter k is set to be a positive constant with respect to the second cost in the above equation (5). By setting above, if the sums of the absolute value of each pixel are substantially the same for both reference frames, the first reference frame has a high possibility to be selected. As a result, a deviation occurs in the appearance frequency of the index of the reference frame. Therefore, by assigning a code having a shorter bit length to the first reference frame, whose appearance frequency is higher, and a code having a longer bit length to the second reference frame, the amount of the data of the generated output video signal can be decreased.

Furthermore, the parameter k can be the amount of the data generated by variable-length-coding the index of the reference frame. When the index of the reference frame is variable-length-coded, the amount of the data generated by variable-length-coding the index of the reference frame depends on whether the index of the reference index is the “first” or the “second”. Therefore, by calculating the cost in consideration of the amount of the data, the cost calculator 9 can estimate the encoding efficiency more precisely.

The cost calculator 9 can define the cost C based on the following equation (6) using a quality degradation D and a generated coding amount R.

C=D+λ*R (6)

The quality degradation D can be a sum of the absolute differences between the encoding target MB and the local decoded image, for example. The generated coding amount R can be the amount of the data generated by variable-length-coding the quantized data, the motion vector and the index of the reference frame, for example. Comparing with other manner, although it needs more amount of the operation, the cost calculator 9 can estimate the encoding efficiency further more precisely.

### Second Embodiment

The above described first embodiment performs the inter-frame motion prediction coding by selecting one of the first reference frame and the second reference frame obtained by weight-operating. On the other hand, a second embodiment, which will be described below, further performs an intra-frame prediction and selects one of the inter-frame prediction image and an intra-frame prediction image.

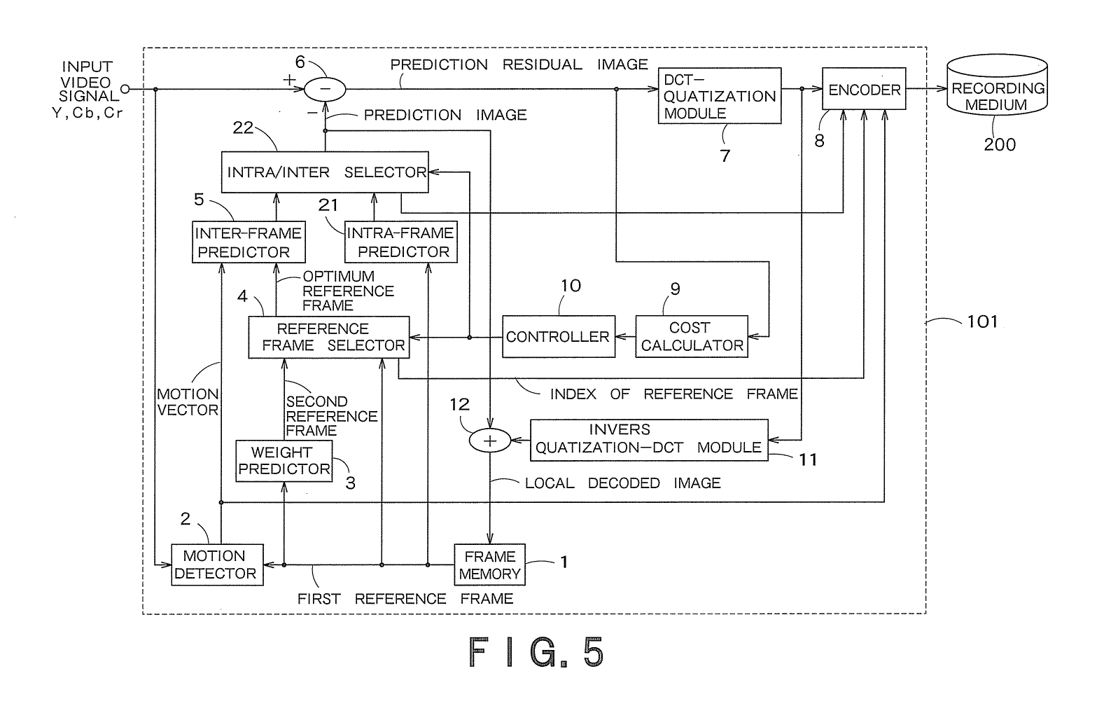

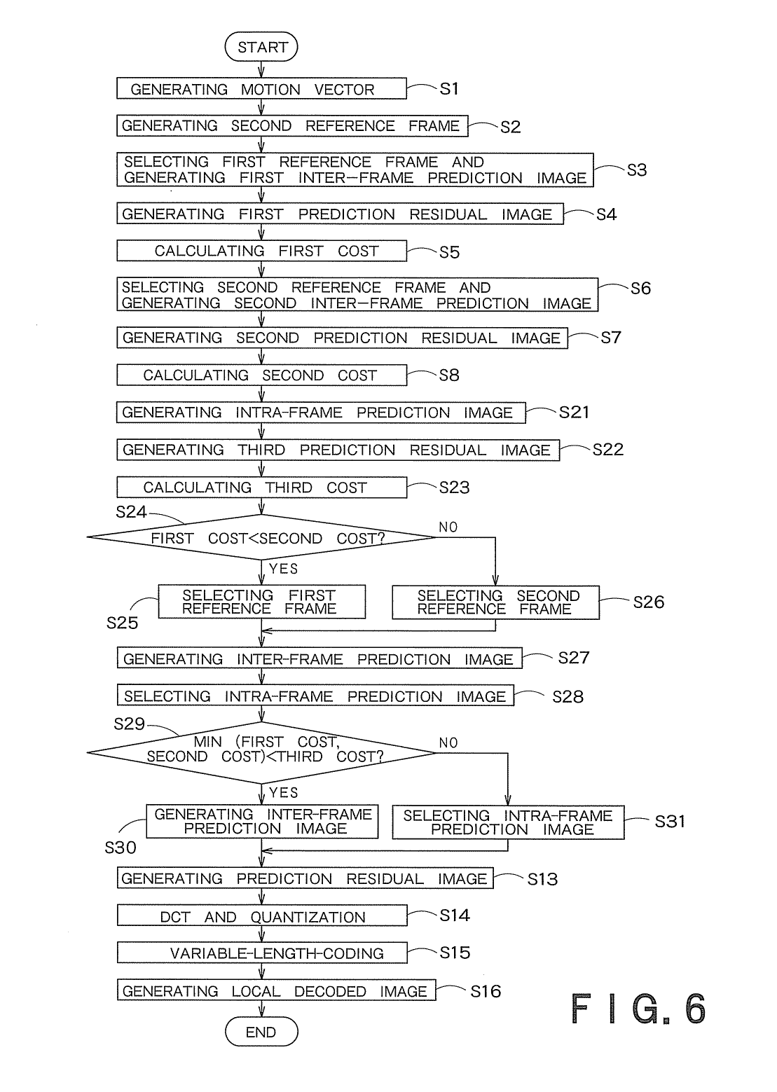

FIG. 5 is a block diagram showing a schematic structure of the image processing system according to the second embodiment. In FIG. 5, components common to those of FIG. 1 have common reference numerals, respectively. Hereinafter, components different from FIG. 1 will be mainly described below.

The image processing device 101 further has an intra-frame predictor 21 and an intra/inter selector 22. The intra-frame predictor 21 generates an intra-frame prediction image by performing an intra-frame prediction using the current local decoded image stored in the frame memory 1. The intra/inter selector 22 selects one of the intra-frame prediction image and the inter-frame prediction image as the optimum prediction image according to the control of the controller 10.

FIG. 6 is a flowchart showing an example of the image processing device 101 of FIG. 5. The explanation of S1 to S8 will be omitted because they are similar to the first embodiment.

The intra-frame predictor 21 generates the intra-frame prediction image by performing the intra-frame prediction (Step S21). As the prediction manner, one of a vertical prediction, a horizontal prediction, an average prediction and a plain prediction is selected, for example. In the vertical prediction mode, pixels in the vertical direction in the MB are predicted using values of pixels located on the upper side of the encoding target MB. In the horizontal prediction mode, pixels in the horizontal direction in the MB are predicted using values of pixels located on the left side of the encoding target MB. In the average prediction mode, all the pixels in the MB are predicted using values of pixels located on the upper side and left side of the encoding target MB. In the plain prediction mode, pixels are predicted by interpolating pixels located on the upper side of the MB and pixels located on the left side of the MB in the diagonal direction. If the variation of the video signal in the frame is small, the intra-frame prediction image can be generated with high accuracy.

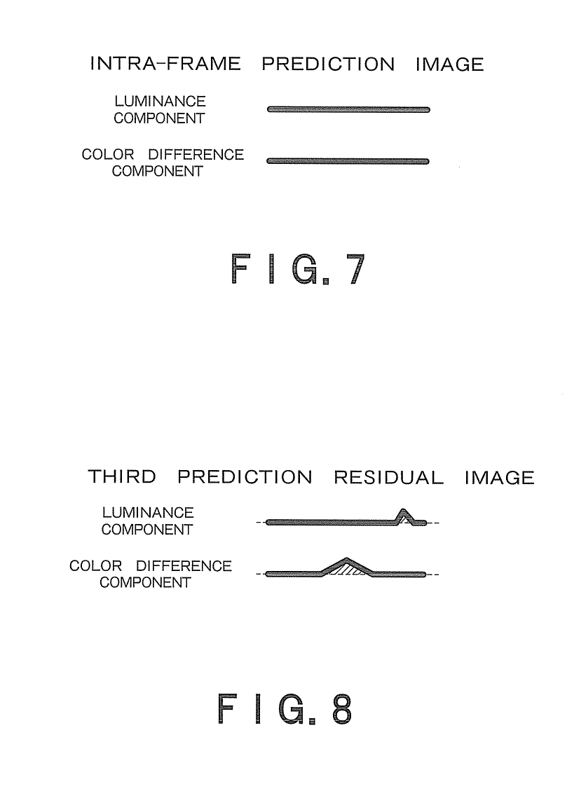

FIG. 7 is an example of the intra-frame prediction image. FIG. 7 shows an example where the average prediction is applied to the encoding target MB of FIG. 3A, and the luminance component Y and the color difference components Cb, Cr are constant values.

Then, the subtractor 6 generates a third prediction residual image by calculating the difference between the encoding target MB and the intra-frame prediction image by each pixel (Step S22). FIG. 8 is an example of the third prediction residual image. The third prediction residual image of FIG. 8 is a difference between the encoding target MB of FIG. 3A and the intra-frame prediction image of FIG. 7.

Next, the cost calculator 9 calculates the third cost which is a cost for performing the compression-coding by using the intra-frame prediction image (Step S23). Similar to the first and the second cost, the cost calculator 9 defines a sum of the absolute values of the third prediction residual image as the third cost, for example. That is, the third cost corresponds to an area where diagonal lines are drawn in FIG. 8. As the accuracy of the intra-prediction is higher, the third cost becomes lower.

Next, one of the first inter-frame prediction image, the second inter-frame prediction image and the intra-frame prediction image, which can minimize the cost, is selected by following S24 to S31. First, the controller 10 compares the first cost with the second cost (S24). The reference frame selector 4 selects the first reference frame (S25) when the first cost is smaller (S24—YES), and selects the second reference frame (S26) when the second cost is smaller (S24—NO).

Then, the inter-frame predictor 5 generates the inter-frame prediction image using the first reference image or the second reference image (S27), and the intra-frame predictor generates the intra-frame prediction image (S28). Furthermore, the controller 10 compares smaller one of the first cost and the second cost with the third cost (S29). The intra/inter selector 22 selects the inter frame prediction image (S30) when the former is smaller (S29—YES) and selects the intra-frame prediction image (S31) when the latter is smaller (S29—NO).

After that, the input video signal is compression-coded using the selected prediction image by the processings of S13 to S16, similar to the first embodiment.

As described above, the second embodiment generates the inter-frame prediction image by using the optimum reference frame and the motion vector, and generates the intra-frame prediction image. Furthermore, the second embodiment performs the compression-coding by selecting one of the inter-frame prediction image and the intra-frame prediction image so as to be able to performing the compression coding more efficiently. Therefore, the moving image can be compression-coded with high quality without lowering the compression ratio. Note that, in each of the above described embodiments, an example has been described where the moving image is compression-coded in the H.264 scheme. However, the embodiments are applicable even when the moving image is compression-coded in other scheme where the moving image is compression-coded by performing the inter-frame motion prediction coding such as the MPEG-2.

At least a part of the image processing system explained in the above embodiments can be formed of hardware or software. When the image processing system is partially formed of the software, it is possible to store a program implementing at least a partial function of the image processing system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the image processing system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An image processing device comprising:
a motion detector configured to generate a motion vector using a luminance component of a first reference frame and a luminance component of an encoding target macro block in an input video signal, the first reference frame being obtained by decoding an encoded frame;
a weight predictor configured to generate a second reference frame comprising a luminance component identical to the luminance component of the first reference frame and color difference components different from the color difference components of the first reference frame;
a reference frame selector configured to select one of the first reference frame and the second reference frame as an optimum reference frame, the optimum reference frame being selected to enhance an encoding efficiency;
an inter-frame predictor configured to generate an inter-frame prediction image based on the motion vector and the selected optimum reference image;
a subtractor configured to calculate a prediction residual image between the encoding target macro block and the inter-frame prediction image;
an orthogonal-transferring-quantization module configured to generate quantized data by orthogonal-transferring and quantizing the prediction residual image; and
an encoder configured to generate the output video signal by encoding the quantized data.

2. The device of claim 1, further comprising:
a cost calculator configured to calculate a first cost and a second cost, the first cost being calculated based on the motion vector, the first reference frame and the encoding target macro block and being indicative of the encoding efficiency in a case where the first reference frame is selected, the second cost being calculated based on the motion vector, the second reference frame and the encoding target macro block and being indicative of the encoding efficiency in a case where the second reference frame is selected; and
a controller configured to control the reference frame selector based on a result of comparing the first cost with the second cost.

3. The device of claim 2, wherein the cost calculator is configured to calculate a sum of each absolute difference between a first inter-frame prediction image and the encoding target macro block by each pixel as the first cost, the first inter-frame prediction image being generated based on the motion vector and the first reference frame, and
the cost calculator is further configured to calculate a sum of each absolute difference between a second inter-frame prediction image and the encoding target macro block by each pixel as the second cost, the second inter-frame prediction image being generated based on the motion vector and the second reference frame.

4. The device of claim 2, wherein the cost calculator is configured to calculate the first cost by adding a first value to a sum of each absolute difference between a first inter-frame prediction image and the encoding target macro block by each pixel, the first inter-frame prediction image being generated based on the motion vector and the first reference frame and
the cost calculator is further configured to calculate the second cost by adding a second value to a sum of each absolute difference between a second inter-frame prediction image and the encoding target macro block by each pixel, the second inter-frame prediction image being generated based on the motion vector and the second reference frame.

5. The device of claim 1, wherein the weight predictor is configured to generate the color difference component of the second reference frame by multiplying the color difference component of the first reference frame by a first constant and then adding a second constant to the multiplied value.

6. The device of claim 5, wherein the first constant is “0”, and the second constant is half of a maximum value of the color component or is an average value of the color difference component of an encoding target frame in the input video signal.

7. The device of claim 1, wherein the encoder is configured to encode the quantized data added by the motion vector and information indicative of whether the first reference frame is selected or the second reference frame is selected.

8. The device of claim 1, further comprising:
an intra-frame predictor configured to generate an intra-frame prediction image based on the first reference frame, and
an intra/inter selector configured to select one of the intra-frame prediction image and the inter-frame prediction image as an optimum prediction image, the optimum prediction image being selected to enhance the encoding efficiency;
wherein the subtractor is configured to calculate the prediction residual image between the encoding target macro block and the optimum prediction image.

9. The device of claim 8, further comprising:
a cost calculator configured to calculate a first cost, a second cost, and a third cost, the first cost being calculated based on the motion vector, the first reference frame and the encoding target macro block and being indicative of the encoding efficiency in a case where the first reference frame is selected, the second cost being calculated based on the motion vector, the second reference frame and the encoding target macro block and indicative of the encoding efficiency in a case where the second reference frame is selected, the third cost being calculated based on the intra-frame prediction image and the encoding target macro block and being indicative of the encoding efficiency in a case where the intra-frame prediction image is selected; and
a controller configured to control the intra/inter selector depending on a result of comparing the first cost, the second cost and the third cost.

10. An image processing system comprising:
a motion detector configured to generates a motion vector using a luminance component of a first reference frame and a luminance component of an encoding target macro block in an input video signal, the first reference frame being obtained by decoding an encoded frame;
a weight predictor configured to generate a second reference frame comprising a luminance component identical to the luminance component of the first reference frame and color difference components different from the color difference components of the first reference frame;
a reference frame selector configured to select one of the first reference frame and the second reference frame as an optimum reference frame, the optimum reference frame being selected to enhance an encoding efficiency;
an inter-frame predictor configured to generate an inter-frame prediction image based on the motion vector and the selected optimum reference image;
a subtractor configured to calculate a prediction residual image between the encoding target macro block and the inter-frame prediction image;
an orthogonal-transferring-quantization module configured to generate quantized data by orthogonal-transferring and quantizing the prediction residual image;
an encoder configured to generate the output video signal by encoding the quantized data; and
a recording medium configured to store the output video signal.

11. The system of claim 10, further comprising:
a cost calculator configured to calculate a first cost and a second cost, the first cost being calculated based on the motion vector, the first reference frame and the encoding target macro block and being indicative of the encoding efficiency in a case where the first reference frame is selected, the second cost being calculated based on the motion vector, the second reference frame and the encoding target macro block and being indicative of the encoding efficiency in a case where the second reference frame is selected; and
a controller configured to control the reference frame selector based on a result of comparing the first cost with the second cost.

12. The system of claim 11, wherein the cost calculator is configured to calculate a sum of each absolute difference between a first inter-frame prediction image and the encoding target macro block by each pixel as the first cost, the first inter-frame prediction image being generated based on the motion vector and the first reference frame, and
the cost calculator is further configured to calculate a sum of each absolute difference between a second inter-frame prediction image and the encoding target macro block by each pixel as the second cost, the second inter-frame prediction image being generated based on the motion vector and the second reference frame.

13. The system of claim 11, wherein the cost calculator is configured to calculate the first cost by adding a first value to a sum of each absolute difference between a first inter-frame prediction image and the encoding target macro block by each pixel, the first inter-frame prediction image being generated based on the motion vector and the first reference frame and
the cost calculator is further configured to calculate the second cost by adding a second value to a sum of each absolute difference between a second inter-frame prediction image and the encoding target macro block by each pixel, the second inter-frame prediction image being generated based on the motion vector and the second reference frame.

14. The system of claim 10, wherein the weight predictor is configured to generate the color difference component of the second reference frame by multiplying the color difference component of the first reference frame by a first constant and then adding a second constant to the multiplied value.

15. The system of claim 14, wherein the first constant is “0”, and the second constant is half of a maximum value of the color component or is an average value of the color difference component of an encoding target frame in the input video signal.

16. The system of claim 10, wherein the encoder is configured to encode the quantized data added by the motion vector and information indicative of whether the first reference frame is selected or the second reference frame is selected.

17. The system of claim 10, further comprising:
an intra-frame predictor configured to generate an intra-frame prediction image based on the first reference frame, and
an intra/inter selector configured to select one of the intra-frame prediction image and the inter-frame prediction image as an optimum prediction image, the optimum prediction image being selected to enhance the encoding efficiency;
wherein the subtractor is configured to calculate the prediction residual image between the encoding target macro block and the optimum prediction image.

18. The system of claim 17, further comprising:
a cost calculator configured to calculate a first cost, a second cost, and a third cost, the first cost being calculated based on the motion vector, the first reference frame and the encoding target macro block and being indicative of the encoding efficiency in a case where the first reference frame is selected, the second cost being calculated based on the motion vector, the second reference frame and the encoding target macro block and indicative of the encoding efficiency in a case where the second reference frame is selected, the third cost being calculated based on the intra-frame prediction image and the encoding target macro block and being indicative of the encoding efficiency in a case where the intra-frame prediction image is selected; and
a controller configured to control the intra/inter selector depending on a result of comparing the first cost, the second cost and the third cost.

19. An image processing method comprising:
generating a motion vector using a luminance component of a first reference frame and a luminance component of an encoding target macro block in an input video signal, the first reference frame being obtained by decoding an encoded frame;
generating a second reference frame comprising a luminance component identical to the luminance component of the first reference frame and color difference components different from the color difference components of the first reference frame;
selecting one of the first reference frame and the second reference frame as an optimum reference frame, the optimum reference frame being selected to enhance an encoding efficiency;
generating an inter-frame prediction image based on the motion vector and the selected optimum reference image;
calculating a prediction residual image between the encoding target macro block and the inter-frame prediction image;
generating quantized data by orthogonal-transferring and quantizing the prediction residual image; and
generating the output video signal by encoding the quantized data.

20. The method of claim 19, wherein upon selecting one of the first reference frame and the second reference frame comprising:
calculating a first cost and a second cost, the first cost being calculated based on the motion vector, the first reference frame and the encoding target macro block and being indicative of the encoding efficiency in a case where the first reference frame is selected, the second cost being calculated based on the motion vector, the second reference frame and the encoding target macro block and being indicative of the encoding efficiency in a case where the second reference frame is selected; and
controlling the reference frame selector based on a result of comparing the first cost with the second cost.
